(19) United States
(12) Patent Application Publication
(10) Pub. No.: US 2024/0152022 A1
(43) Pub. Date: May 9, 2024

(54) PASSIVE DISPERSION COMPENSATION FOR AN ACOUSTO-OPTIC DEFLECTOR

(71) Applicant: Orbotech Ltd., Yavne (IL)

(72) Inventor: Itay Peled, Jerusalem (IL)

(21) Appl. No.: 17/981,108

(22) Filed: Nov. 4, 2022

(51) Int. Cl. G02F 1/33; G02B 26/10; G02F 1/11

(52) U.S. Cl. CPC G02F 1/33; G02B 26/108; G02F 1/113

(57) ABSTRACT

An optical scanner may include one or more acousto-optic deflectors (AODs) configured to deflect an optical beam along one or more scanning directions, where a deflection angle of the optical beam from the one or more AODs is controllable by one or more drive signals applied to the one or more AODs. The scanner may further include a dispersion compensator, where dispersion by the dispersion compensator at least partly compensates for dispersion by the one or more AODs to provide that the deflection angle of the optical beam at a particular configuration of the one or more drive signals is constant within a first tolerance for wavelengths of the optical beam within a wavelength range, and where at least one of the dispersion of the dispersion compensator or a transmittance of the dispersion compensator is independent of a polarization of the optical beam within a second tolerance.

### TECHNICAL FIELD

The present disclosure is directed generally to an optical beam scanner and, more particularly, to passive dispersion corrections for an optical beam scanner in the presence of spectral variations of a scanned beam.

### BACKGROUND

Acousto-optic deflectors (AODs) may be used as optical beam scanning devices in a wide range of applications. AODs beneficially provide relatively fast scanning speeds, but are sensitive to spectral variations of an optical beam being scanned. It may therefore be desirable to develop systems and methods to cure the above deficiencies

### SUMMARY

An optical scanner is disclosed in accordance with one or more illustrative embodiments of the present disclosure. In one illustrative embodiment, the scanner includes one or more acousto-optic deflectors (AODs) configured to deflect an optical beam along one or more scanning directions, where a deflection angle of the optical beam from the one or more AODs is controllable by one or more drive signals applied to the one or more AODs. In another illustrative embodiment, the scanner includes a dispersion compensator, where dispersion by the dispersion compensator at least partly compensates for dispersion by the one or more AODs to provide that the deflection angle of the optical beam by the one or more AODs and the dispersion compensator at a particular configuration of the one or more drive signals is constant within a first tolerance for wavelengths of the optical beam within a wavelength range, and where at least one of the dispersion of the dispersion compensator or a transmittance of the dispersion compensator is independent of a polarization of the optical beam within a second tolerance.

A method is disclosed in accordance with one or more illustrative embodiments of the present disclosure. In one illustrative embodiment, the method includes deflecting an optical beam with an AOD along one or more scanning directions, where a deflection angle of the optical beam from the AOD is controllable by one or more drive signals applied to the AOD. In another illustrative embodiment, the method includes dispersing the optical beam with a dispersion compensator, where dispersion by the dispersion compensator at least partly compensates for dispersion by the AOD such that a deflection angle of the optical beam from the AOD and the dispersion compensator at a particular configuration of the one or more drive signals is constant within a first tolerance for wavelengths of the optical beam within a wavelength range, and where at least one of the dispersion by the dispersion compensator or a transmittance of the dispersion compensator is independent of a polarization of the optical beam within a second tolerance.

An optical scanner is disclosed in accordance with one or more illustrative embodiments of the present disclosure. In one illustrative embodiment, the scanner includes a dispersion compensator formed as a diffractive optical element (DOE) configured to diffract an optical beam into two or more diffracted beams along two or more directions, where at least one of dispersion by the dispersion compensator or a transmittance of the dispersion compensator is independent of a polarization of the optical beam within a first tolerance. In another illustrative embodiment, the scanner includes two or more AODs to receive the two or more diffracted beams and deflect the two or more diffracted beams, where deflection angles of the diffracted beams from the two or more AODs are controllable by drive signals applied to the two or more AODs, and where dispersion by the dispersion compensator at least partly compensates for dispersion by the two or more AODs to provide that the deflection angles of the diffracted beams by the dispersion compensator and the two or more AODs at a particular configuration of the one or more drive signals are constant within a second tolerance for wavelengths of the optical beam within a wavelength range.

A system is disclosed in accordance with one or more illustrative embodiments of the present disclosure. In one illustrative embodiment, the system includes an optical source configured to generate an optical beam. In another illustrative embodiment, the system includes a scanner. In another illustrative embodiment, the scanner includes one or more AODs configured to deflect an optical beam along one or more scanning directions, where a deflection angle of the optical beam from the one or more AODs is controllable by one or more drive signals applied to the one or more AODs. In another illustrative embodiment, the scanner includes a dispersion compensator, where dispersion by the dispersion compensator at least partly compensates for dispersion by the one or more AODs such that the deflection angle of the optical beam by the dispersion compensator and the one or more AODs at a particular configuration of the one or more drive signals is constant within a first tolerance for wavelengths of the optical beam within a wavelength range, and where at least one of the dispersion by the dispersion compensator or a transmittance of the dispersion compensator is independent of a polarization of the optical beam within a second tolerance. In another illustrative embodiment, the system includes one or more focusing optics configured to focus the optical beam deflected by the one or more AODs to a sample.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is a block diagram of an optical scanner, in accordance with one or more embodiments of the present disclosure.

FIG. 2 is a simplified schematic of an acousto-optic deflector (AOD), in accordance with one or more embodiments of the present disclosure.

FIG. 3A is a simplified schematic of an AOD exhibiting dispersion, in accordance with one or more embodiments of the present disclosure.

FIG. 3B is a simplified schematic of a dispersion compensator exhibiting an opposite dispersion as the AOD in FIG. 3A, in accordance with one or more embodiments of the present disclosure.

FIG. 4 is a block diagram of the optical scanner including a dispersion compensator 108 located in a path of an optical beam prior to an AOD, in accordance with one or more embodiments of the present disclosure.

FIG. 5 is a simplified schematic of an optical scanner including a dispersion compensator in a path of an optical beam prior to an AOD, in accordance with one or more embodiments of the present disclosure.

FIG. 6A is a block diagram of an optical scanner including an optical relay to image the dispersion compensator on an AOD, in accordance with one or more embodiments of the present disclosure.

FIG. 6B is a simplified schematic of an optical scanner including an optical relay to image the dispersion compensator on an AOD, in accordance with one or more embodiments of the present disclosure.

FIG. 7 is a conceptual view of the relative dispersion directions of a dispersion compensator and a single AOD arranged for 1D scanning in the Y-Z plane, in accordance with one or more embodiments of the present disclosure.

FIG. 8 is a conceptual view of the relative dispersion directions of a dispersion compensator and two AODs arranged for 2D scanning, in accordance with one or more embodiments of the present disclosure.

FIG. 9 is a block diagram of an optical scanner with a polarization insensitive dispersion compensator arranged to provide dispersion compensation for two orthogonal polarization-sensitive AODs, in accordance with one or more embodiments of the present disclosure.

FIG. 10 is a block diagram of an optical scanner including a beamsplitter to split a received optical beam into four channels, each including at least one AOD, in accordance with one or more embodiments of the present disclosure.

FIG. 11 is a block diagram of an optical scanner including a dispersion compensator providing both dispersion compensation and beamsplitting, in accordance with one or more embodiments of the present disclosure.

FIG. 12 is a block diagram of a system including an optical scanner, in accordance with one or more embodiments of the present disclosure.

FIG. 13 is a flow diagram illustrating steps performed in a method for passive dispersion compensation of an acousto-optic deflector, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for passive dispersion correction of an acousto-optic deflector (AOD) to compensate for spectral variations of an optical beam (e.g., a laser beam, or the like). In some embodiments, an optical scanner includes an acousto-optic deflector (AOD) to receive and redirect an optical beam (e.g., scan an optical beam) and a dispersion compensator.

An AOD may include one or more transducers to generate acoustic waves in a host material, where driving the transduces with a periodic drive signal may form a diffraction grating in the host material. In this way, an incident optical beam may be redirected via diffraction, where a deflection angle of the optical beam from the AOD (e.g., a diffraction angle from the diffraction grating) may be controlled based on a frequency of the drive signal and an intensity of the optical beam from the AOD may be controlled based on an amplitude of the drive signal.

It is contemplated herein that such an AOD may beneficially provide higher scanning speeds than mechanical scanners (e.g., galvo mirrors, rotating polygons, or the like), but may be highly sensitive to spectral variations of an optical beam being scanned. In particular, spectral variations of the optical beam may result in variations of a diffraction angle of the optical beam by the AOD and thus variations in the deflection angle of the optical beam. However, the systems and methods disclosed herein may allow for passive compensation of spectral variations to provide fast and accurate optical scanning with an AOD despite spectral variations.

In some embodiments, an optical scanner includes a dispersion compensator having an opposite dispersion as the AOD (e.g., a dispersion of equal magnitude and opposite direction). Different wavelengths of light from the dispersion compensator may thus be incident on the AOD at different angles to provide that the different wavelengths have the same deflection angle. As a result, the optical scanner may provide an accurate deflection angle (e.g., pointing direction) despite spectral variations of the optical beam being scanned.

In some embodiments, the dispersion compensator is polarization insensitive. In this way, the incident optical beam may have any suitable polarization and may in some cases be unpolarized. It is contemplated herein that polarization-insensitive performance may facilitate higher powers of the optical beam, particularly when the optical beam from the optical source is unpolarized.

In some embodiments, the dispersion compensator and the AOD are compatible with operation in the mid-infrared (MIR) wavelengths. For example, the dispersion compensator and the AOD may be formed with materials suitable for operation with an optical beam from a CO₂ laser (e.g., ZnSe, or the like), which may operate with wavelengths in the 9-12 micrometer range.

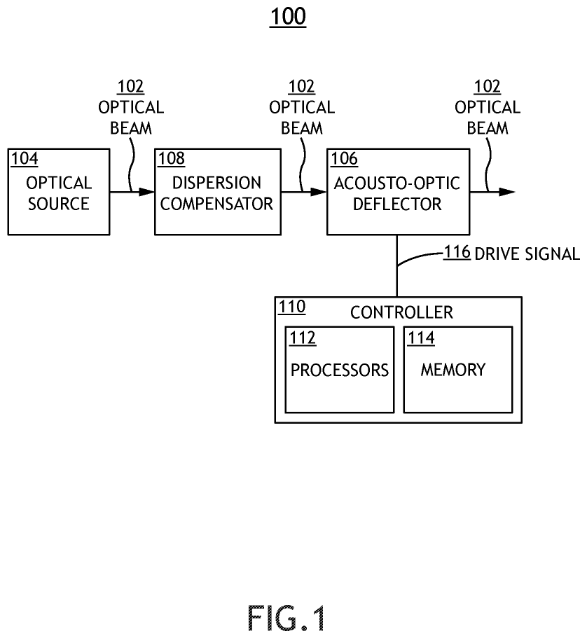

Referring now to FIGS. 1-12, systems and methods for passive dispersion correction of an acousto-optic deflector (AOD) are described in greater detail, in accordance with one or more embodiments of the present disclosure.

FIG. 1 is a block diagram of an optical scanner 100, in accordance with one or more embodiments of the present disclosure.

In some embodiments, the optical scanner 100 is configured to receive an optical beam 102 (e.g., from an optical source 104), an AOD 106 to control a deflection angle of the optical beam 102, and a dispersion compensator 108 having an opposite dispersion as the AOD 106 to at least partially compensate for dispersion in the AOD 106.

The optical beam 102 may include one or more selected wavelengths of light including, but not limited to, ultraviolet (UV) radiation, visible radiation, or infrared (IR) radiation. Further, the optical beam 102 from the optical source 104 may have any temporal profile including, but not limited to, a continuous-wave (CW) profile, a pulsed profile, or a modulated profile.

The optical source 104 may generally include any type of illumination source suitable for providing at least one optical beam 102 including, but not limited to, a laser source or a light emitting diode (LED). It is noted that the optical source 104 may be integrated within the optical scanner 100, the system 1200, or as an external component. In some embodiments, the optical source 104 includes a narrowband laser source providing light centered around a center wavelength. It is contemplated herein that the smaller a bandwidth of the optical beam 102, the less spatial dispersion will be induced by a dispersive element such as, but not limited to, an AOD 106.

In some embodiments, the optical source 104 is a carbon dioxide (CO₂) laser source. For example, a CO₂ laser may provide an optical beam 102 having a wavelength in a range of 9-12 micrometers, though this is indented to be illustrative rather than limiting.

The optical scanner 100 may further include a controller 110 with one or more processors 112 configured to execute a set of program instructions maintained in memory 114 (e.g. a memory device), where the controller 110 may generate at least one drive signal 116 for the AOD 106. In this way, the controller 110 may direct or otherwise control AOD 106 to direct the optical beam 102 along a particular deflection angle, scan pattern, or the like based on the drive signal 116 (e.g., based on a frequency of the drive signal 116).

The one or more processors 112 of a controller 110 may include any processor or processing element known in the art. In this sense, the one or more processors 112 may include any microprocessor-type device configured to execute algorithms and/or instructions. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 112 may include any device configured to execute algorithms and/or instructions (e.g., program instructions stored in memory). In some embodiments, the one or more processors 112 may be embodied as a desktop computer, mainframe computer system, workstation, image computer, parallel processor, networked computer, or any other computer system configured to execute a program configured to operate or operate in conjunction with the optical scanner 100, as described throughout the present disclosure. Moreover, different subsystems of the optical scanner 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 110 may include one or more controllers housed in a common housing or within multiple housings. In this way, any controller or combination of controllers may be separately packaged as a module suitable for integration into the optical scanner 100.

The memory 114 may include any storage medium known in the art suitable for storing program instructions executable by the associated one or more processors 112. For example, the memory 114 may include a non-transitory memory medium. By way of another example, the memory 114 may include, but is not limited to, a read-only memory (ROM), a random-access memory (RAM), a magnetic or optical memory device (e.g., disk), a magnetic tape, a solid-state drive and the like. It is further noted that the memory 114 may be housed in a common controller housing with the one or more processors 112. In some embodiments, the memory 114 may be located remotely with respect to the physical location of the one or more processors 112 and the controller 110. For instance, the one or more processors 112 of the controller 110 may access a remote memory (e.g., server), accessible through a network (e.g., internet, intranet and the like).

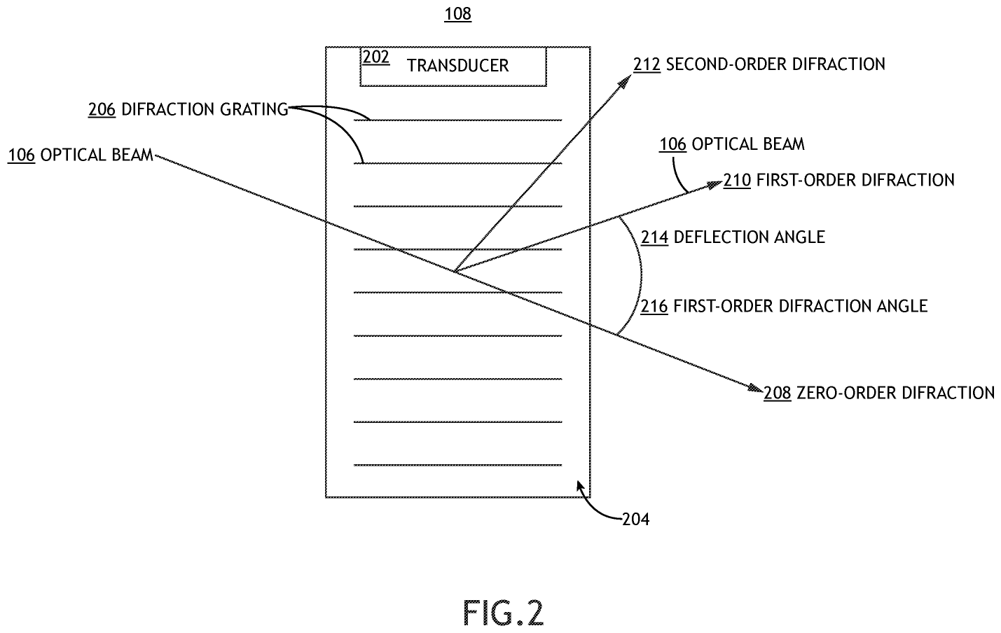

Referring now to FIGS. 2-11, the operation of the AOD 106 and the dispersion compensator 108 for at least partially compensating for the dispersion of the AOD 106 are described in greater detail, in accordance with one or more embodiments of the present disclosure.

The AOD 106 may include any type of deflector known in the art suitable for controlling a deflection angle of the optical beam 102 through diffraction by acoustic waves in a material. FIG. 2 is a simplified schematic of an AOD 106, in accordance with one or more embodiments of the present disclosure.

In some embodiments, the AOD 106 includes at least one transducer 202 coupled to a host material 204. The host material 204 may include any type of material suitable for interaction with the optical beam 102 such as, but not limited to, a glass or a crystal. For example, the host material 204 may be transparent to the optical beam 102. As an illustration, the host material 204 may have an absorptivity for wavelengths associated with the optical beam 102 below a selected threshold and/or may have a transmittance for wavelengths associated with the optical beam 102 above a selected threshold.

A transducer 202 may be any component suitable for generating acoustic waves in the host material 204. In some embodiments, A transducer 202 is a piezoelectric material that may expand or contract in response to an applied voltage (e.g., a drive signal 116), which may generate an acoustic wave in the host material 204.

In some embodiments, the AOD 106 (e.g., one or more transducers in an AOD 106) is driven by a periodic drive signal 116 to generate a periodic distribution of acoustic waves in the host material 204, which may operate as a diffraction grating 206 suitable for diffracting the optical beam 102. In particular, the periodic distribution of acoustic waves may provide a periodic distribution of refractive index in the host material 204 that operates as a diffraction grating 206.

Diffraction of the optical beam 102 by the diffraction grating 206 may generally result in any number of diffraction orders (e.g., zero-order diffraction 208, first-order diffraction 210, second-order diffraction 212, or the like). Diffraction of the optical beam 102 by the diffraction grating 206 in the AOD 106 may generally be governed by the grating equation:

d(sin θᵢ−sin θₘ)=mλ (1)
where d is the period of the diffraction grating 206, m is the diffraction order, λ is the wavelength of the optical beam 102, θᵢ is the incidence angle of the optical beam 102, and θₘ is the diffraction angle of the associated diffraction order of the optical beam 102.

In this configuration, any of the diffraction orders may be utilized as a deflected optical beam 102. In this way, a deflection angle 214 of the optical beam 102 may correspond to the diffraction angle (θₘ) of a selected diffraction order.

In some embodiments, the AOD 106 is configured such that the optical beam 102 interacts with the diffraction grating 206 at or near the Bragg angle such that a substantial portion of the energy in the optical beam 102 is diffracted as first-order diffraction 210 (e.g., +1 order diffraction or −1 order diffraction). Accordingly, the first-order diffraction 210 may represent a deflected optical beam 102 and a deflection angle 214 of the optical beam 102 from the AOD 106 may correspond to the first-order diffraction angle 216.

In this configuration, the deflection angle 214 corresponds to a first-order diffraction angle 216:

θ₁=a sin(sin θᵢ−λ\d) (2)

More generally, Equations (1) and (2) illustrates that non-zero diffraction orders including, but not limited to, first-order diffraction 210 are spectrally dispersed such that the angle of diffraction θₘ varies based on the wavelength (λ) of the optical beam 102. Put another way, the AOD 106 may exhibit an angular dispersion (D) that results in a variation of the deflection angle 214 of an optical beam as a function of wavelength (λ), which may generally be characterized as:

$${D}_{AOD} = \frac{\partial {θ}_{m}}{\partial λ} , \qquad ( 3 )$$

where m may be, but is not required to be, 1 to correspond to first-order diffraction 210.

The power of the first-order diffraction 210 and thus the efficiency of the AOD 106 for deflecting the optical beam 102 may depend on various factors including, but not limited to, the magnitude of the variation of refractive index of the host material 204 (Δn, where n is the refractive index of the host material 204) associated with the diffraction grating 206, which may be referred to as the modulation depth of the diffraction grating 206. In an AOD 106, this modulation depth (Δn) may be based on an amplitude of an acoustic wave generated by the transducer 202.

For a given wavelength (λ) of the optical beam 102, the first-order diffraction angle 216 and thus the deflection angle 214 of the optical beam 102 from the AOD 106 may be varied within a scan range (e.g., a walking window) by adjusting a frequency of the drive signal 116. The period (d) of the diffraction grating 206 may be inversely related to the frequency of the drive signal 116. For example, the controller 110 may generate the drive signal 116 and may adjust the frequency of the drive signal 116 in any selected pattern to adjust the deflection angle 214 in any selected pattern.

It is contemplated herein that the optical source 104 may exhibit various instabilities such as, but not limited to, instabilities in the spectrum or the beam size of the optical beam 102. In the case of a laser source, such instabilities may be, but are not required to be, associated with mode hopping between different supported modes, each of which may have a different wavelength (e.g., central wavelength).

Spectral variations of the optical beam 102 (e.g., associated with such instabilities of the optical source 104 or more generally associated with any mechanism) may induce errors of the deflection angle of the optical beam 102. Considering the illustration in FIG. 2 as a non-limiting example, spectral variations of the optical beam 102 may affect the first-order diffraction angle 216 and thus the deflection angle 214 of the optical beam 102 from the AOD 106 based on Equations (1)-(3). As a result, a shift of the wavelength (λ) of the optical beam 102 from an expected value (e.g., due to a spectral variation) may result in an error of the deflection angle 214 from the AOD 106.

While it may be possible to avoid such deflection angle errors by either using a wavelength insensitive scanning technique (e.g., a mechanical technique such as, but not limited to, galvo mirrors or rotating polygons) or selecting an optical source 104 having reduced spectral variations, such approaches are not always desirable. For example, mechanical beam scanning techniques may generally have slower positioning rates (e.g., scan rates) and may thus limit the throughput of a system. As another example, techniques providing an optical beam 102 with high spectral stability may limit the achievable power of the optical beam 102. Put another way, mode hopping (and the associated spectral instability) may be a consequence of high-power operation of some laser sources such as, but not limited to CO₂ laser sources.

Accordingly, it may be desirable in some applications to utilize an optical scanner 100 including an AOD 106 in combination with an optical source 104 exhibiting spectral variations.

In this way, the optical source 104 may be selected to provide an optical beam 102 with a selected power without regard to spectral instabilities without sacrificing scanning speed or precision.

In some embodiments, the optical scanner 100 includes the dispersion compensator 108 to at least partially compensate for the dispersion of the AOD 106 to provide a deflection angle 214 that is insensitive to the spectral variations of the optical beam 102 (at least within a selected tolerance and within selected operating conditions).

The dispersion compensator 108 may include any optical element known in the art suitable for introducing dispersion to an optical beam 102. In some embodiments, the dispersion compensator 108 is a prism (e.g., a wedged window). In some embodiments, the dispersion compensator 108 is a diffractive optical element (DOE). It is contemplated herein that it may be impractical or impossible to provide a prism as a dispersion compensator for certain wavelength ranges such as, but not limited to, mid-infrared to far-IR spectral regions. As an illustration, designing a prism suitable for dispersion compensation of wavelengths associated with an optical beam from a carbon dioxide (CO₂) laser system may present challenges for dispersion compensation since the number of materials transparent to such wavelengths are limited (e.g., ZnSe, or the like) and may not provide acceptable refractive index and/or resistance to damage. However, it may be the case that a DOE may be fabricated with nearly 100% transmission into first-order diffraction at these wavelengths and may further withstand high powers.

A dispersion compensator 108 formed as a DOE may include any type of DOE known in the art. For example, a DOE may generally include a solid material transparent to wavelengths of interest for a particular optical beam 102 that includes structures arranged to impart a selected spatial distribution of optical phase on the optical beam 102, which may be used to control various properties of the output optical beam 102 such as, but not limited to, a propagation direction, a beam distribution, or focal properties. For example, the DOE may have a spatially varying optical path length based on any combination of spatially-varying thickness or refractive index. Further, the dispersion compensator 108 may be a passive device and may thus have fixed dispersion properties (D_{DC}). In some embodiments, a dispersion compensator 108 formed as a DOE includes periodic structures (e.g., lines, circles, contour shapes, or the like) having a period selected to diffract the optical beam 102 into one or more diffraction orders. Such a DOE may thus be characterized as a diffraction grating or a diffractive element more generally.

Further, a dispersion compensator 108 formed as a DOE may be fabricated using any suitable technique. For example, a distribution of spatially-varying thickness may be, but is not required to be, fabricated using photolithographic techniques based on lithographic exposure of a photoresist and subsequent etching. As another example, a distribution of spatially-varying thickness may be, but are not required to be, fabricated using direct laser writing techniques or exposure of a photosensitive material with a desired pattern of light to induce a desired structural change in a substrate.

In some embodiments, the dispersion compensator 108 is polarization insensitive such that the incident optical beam 102 may have any suitable polarization and/or may be unpolarized. In this way, at least one of a dispersion provided by the dispersion compensator 108 or a transmittance of the dispersion compensator 108 (e.g., a power of the optical beam 102 exiting the dispersion compensator 108 relative to a power of the optical beam 102 entering the dispersion compensator 108) may not depend on the polarization of the incident optical beam 102 (at least within a specified tolerance). For example, the dispersion and/or a transmittance of a polarization insensitive dispersion compensator 108 may be constant with a tolerance of a selected percentage for different input polarizations of the optical beam 102.

It is contemplated herein that a polarization insensitive dispersion compensator 108 may reduce the need for polarization-manipulating optics such as, but not limited to, polarizers and/or polarization retarders (e.g., polarization rotators, waveplates, or the like) to manipulate the polarization of the optical beam 102 prior to the dispersion compensator 108. Such polarization-manipulation optics may be impractical to fabricate for certain wavelength and/or power ranges of the optical beam 102. As an illustration, it may be impractical to provide such polarization-manipulation optics for an optical beam 102 from a CO₂ laser, particularly at relatively high powers such as, but not limited to, tens to hundreds of kilowatts. For instance, it may be impractical to provide birefringent materials suitable for this wavelength and power range. However, a polarization-insensitive dispersion compensator 108 may enable operation with an optical beam 102 with any polarization characteristics.

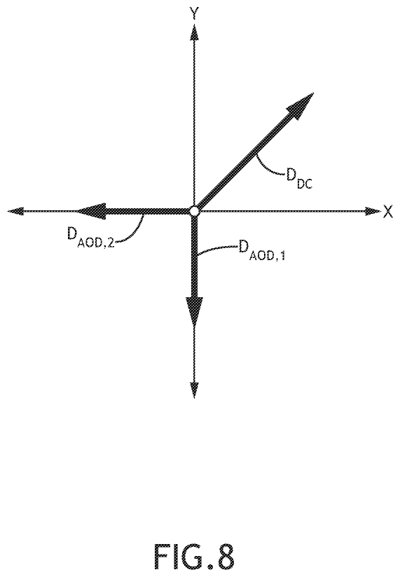

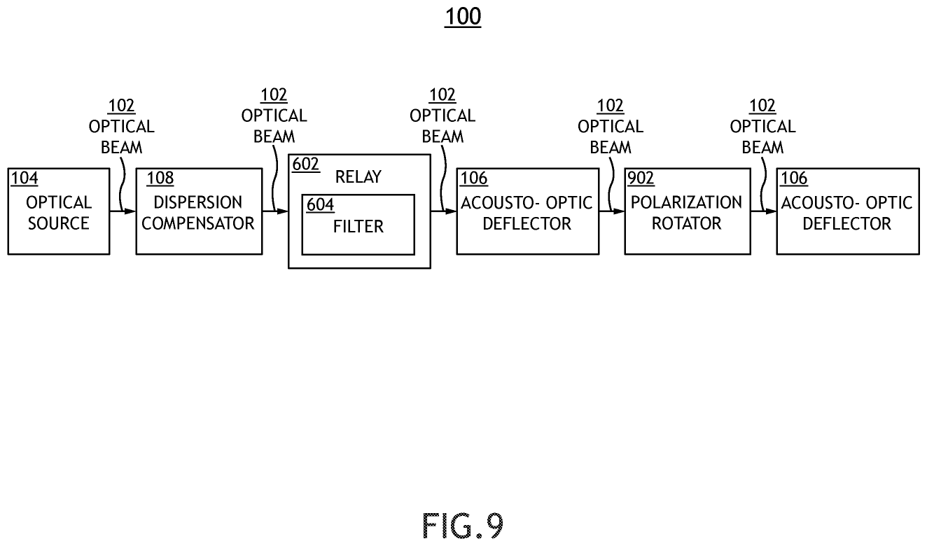

As will be described in greater detail with respect to FIGS. 8-9, a polarization insensitive dispersion compensator 108 be particularly suitable for, but is not limited to, providing dispersion compensation for multiple AODs 106 (e.g., oriented along orthogonal directions) with a single element. In contrast, multiple polarization sensitive dispersion compensator would be required for such an application, which would decrease overall throughput and increase system cost.

A polarization-insensitive dispersion compensator 108 may also facilitate higher powers of the optical beam when the optical beam 102 from the optical source 104 is unpolarized. For example, in the case when the optical beam 102 from the optical source 104 is unpolarized, conversion of the optical beam 102 to a linear polarization (e.g., using a polarizer) may substantially reduce the usable power of the optical beam 102 (e.g., by up to 50%). Additionally, a polarization-insensitive dispersion compensator 108 may eliminate power fluctuations associated with losses through polarization-sensitive components due to polarization shifts of the optical beam 102.

A dispersion compensator 108 may operate as a transmissive element or a reflective element. A dispersion compensator 108 operating as a transmissive element may provide dispersed light as transmitted light and may have any structure known in the art. For example, a dispersion compensator 108 operating as a transmissive element may include spatially varying refractive index variations in a pattern suitable for inducing diffraction. A dispersion compensator 108 operating as a reflective element may provide dispersed light as reflected light and may have any structure known in the art. For example, a dispersion compensator 108 operating as a reflective element may be formed as a substrate having surface features (e.g., a patterned surface) suitable for inducing diffraction. As an illustration, such a reflective dispersion compensator 108 may be formed as a semiconductor or metallic surface with patterned surface features that may optionally be coated with one or more additional layers (e.g., dielectric and/or metal layers) to control reflectivity. For some material types, a dispersion compensator 108 operating as a reflective element may be suitable for relatively a higher power optical beam 102 than a transmissive element.

In some embodiments, the dispersion compensator 108 provides a dispersion (D_{DC}) with an equal magnitude and opposite sign (e.g., opposite sign) as the AOD 106, which may be characterized by:

$${D}_{DC} = - {D}_{AOD} = - \frac{\partial {θ}_{m}}{\partial λ} . \qquad ( 4 )$$

For the purposes of the present disclosure, the dispersion compensator 108 is described as having an opposite dispersion as the AOD 106 when Equation (4) is satisfied for at least some operating conditions of the optical scanner 100.

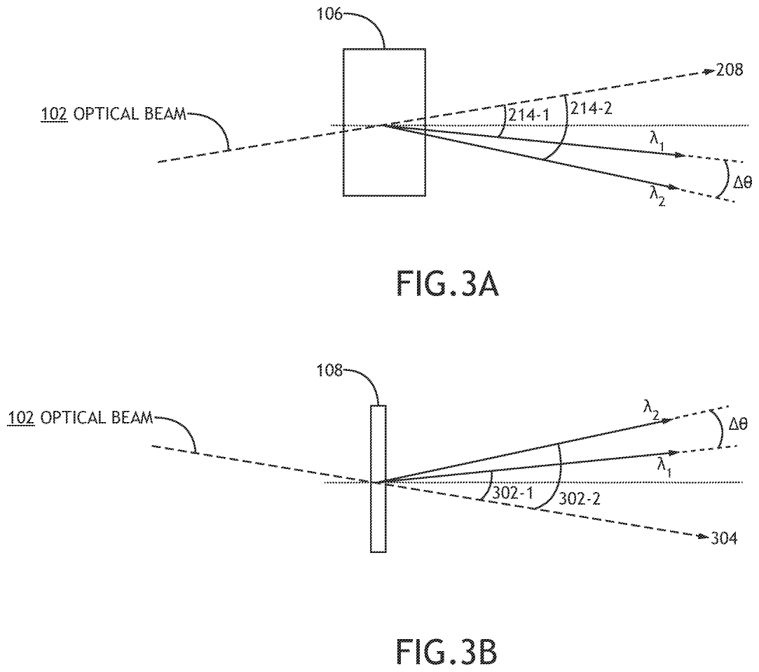

FIGS. 3A and 3B illustrate a dispersion compensator 108 with an opposite dispersion as an AOD 106 for dispersion compensation. FIG. 3A is a simplified schematic of an AOD 106 exhibiting dispersion, in accordance with one or more embodiments of the present disclosure. FIG. 3B is a simplified schematic of a dispersion compensator 108 exhibiting an opposite dispersion as the AOD 106 in FIG. 3A, in accordance with one or more embodiments of the present disclosure.

In FIGS. 3A and 3B, a sign convention is used in which an angle measured in a clockwise direction is considered positive and an angle measured in a negative direction is considered negative.

As depicted in FIG. 3A, an optical beam 102 incident on an AOD 106 exhibiting dispersion may be deflected by different angles based on the wavelength. For example, light with a first wavelength (λ₁) is deflected with a first deflection angle 214-1 and light with a second wavelength (λ₂) is deflected with a second deflection angle 214-2 with respect to zero-order diffraction 208. Both the first deflection angle 214-1 and the second deflection angle 214-2 are positive angles using the sign convention above. The dispersion of the AOD 106 may then correspond to D_{AOD}=Δθ/(λ₂−λ₁), where Δθ corresponds to a difference between the second deflection angle 214-2 and the first deflection angle 214-1.

As depicted in FIG. 3B, a dispersion compensator 108 providing an opposite dispersion as an AOD 106 may provide deflection angles with an opposite sign as the AOD 106 for any sign convention. For example, FIG. 3B depicts the light with the first wavelength (λ₁) deflected with a first deflection angle 302-1 having the same magnitude but opposite sign as the first deflection angle 214-1 provided by the AOD 106 with respect to zero-order diffraction 208. Similarly, the light with the second wavelength (λ₂) is deflected with a second deflection angle 302-2 having the same magnitude but opposite sign as the second deflection angle 214-2 provided by the AOD 106 with respect to zero-order diffraction 304.

It is contemplated herein that the overall performance of an optical scanner 100 including an AOD 106 coupled to a passive dispersion compensator 108 with a fixed dispersion may vary based on operating conditions of the AOD 106 such as, but not limited to, a period (d) of the diffraction grating 206 in the AOD 106. As described previously herein, the deflection angle 214 of the optical beam 102 by the AOD 106 may generally be controlled (e.g., during a scan) by adjusting the period (d) of the diffraction grating 206 through control of the frequency of the drive signal 116 applied to the transducer 202. The optical beam 102 may thus be deflected within an operational range of deflection angles 214 (e.g., a scan range) by controlling the frequency of the drive signal 116 within a commensurate range. However, adjusting the period (d) of the diffraction grating 206 may also change the dispersion of the AOD 106 (D_{AOD}) for particular wavelengths. As a result, the fixed dispersion provided by the dispersion compensator 108 (D_{DC}) may not fully compensate the dispersion of the AOD 106 (D_{AOD}) for all frequencies of the drive signal 116.

In some embodiments, the dispersion compensator 108 is tuned to the operational range of the AOD 106. For example, the dispersion compensator 108 may be, but is not required to be, tuned to a center of the operational range of the AOD 106 (e.g., a center period (d) of the diffraction grating 206 associated with a corresponding center frequency of the drive signal 116). As an illustration considering a dispersion compensator 108 formed with a DOE, a period of the DOE may be selected to be equal to the period (d) of the diffraction grating 206 in the AOD 106 associated with the center of the operational range of the AOD 106.

In this configuration, the dispersion compensator 108 may provide the most accurate dispersion compensation when the AOD 106 is operated with a drive signal 116 frequency in the center of the operational range, while the accuracy of the dispersion compensation may reduce as the frequency of the drive signal 116 deviates from this center value. However, it is contemplated herein that a performance reduction near the edges of the operational range may be acceptable in many applications. In some cases, the performance reduction near the edges of the operational range may be approximately a factor of 3-5.

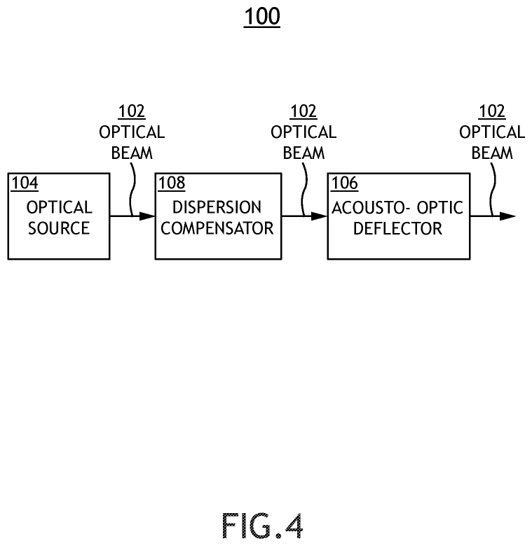

Referring now to FIGS. 4-6, the dispersion compensator 108 may be placed at any location suitable for compensating the dispersion of the AOD 106.

In some embodiments, the dispersion compensator 108 is located in a path of the optical beam 102 after the AOD 106. In this way, the dispersion compensator 108 may at least partially remove dispersion induced by the AOD 106. In some embodiments, the dispersion compensator 108 is located in a path of the optical beam 102 prior to the AOD 106. In this way, the dispersion compensator 108 may introduce dispersion to the optical beam 102 such that this dispersion is at least partially removed upon deflection of the optical beam 102 by the AOD 106.

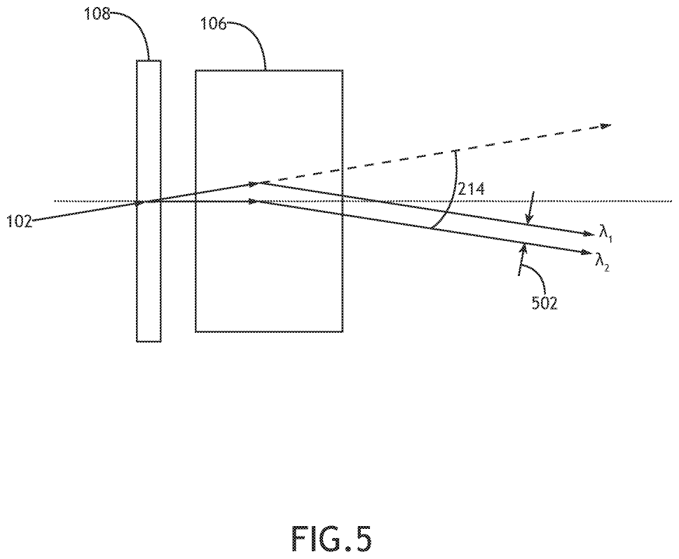

FIG. 4 is a block diagram of the optical scanner 100 including a dispersion compensator 108 located in an a path of an optical beam 102 prior to an AOD 106, in accordance with one or more embodiments of the present disclosure. In some embodiments, a dispersion compensator 108 is located physically near the AOD 106. For example, FIG. 5 is a simplified schematic of an optical scanner 100 including a dispersion compensator 108 in a path of an optical beam 102 prior to an AOD 106, in accordance with one or more embodiments of the present disclosure.

As depicted in FIG. 5, the dispersion of the dispersion compensator 108 (D_{DC}) may cause different wavelengths of light (e.g., λ₁ and λ₂) to reach the AOD 106 at different angles such that the dispersion of the AOD 106 (D_{AOD}) results in a constant deflection angle 214 for the different wavelengths of light. In this way, spectral variations of the optical beam 102 do not impact the deflection angle 214.

It is contemplated herein that placing a dispersion compensator 108 immediately adjacent to the AOD 106 may facilitate simple alignment and may not require additional components to provide dispersion compensation. However, as also depicted in FIG. 5, this configuration may result in a slight lateral displacement (Δl) 502 between light with different wavelengths exiting the AOD 106. In this way, light of different wavelengths may have the same deflection angle 214 but may not be collinear. Rather, the resulting optical beam 102 will be spatially dispersed across the beam profile. The magnitude of this lateral displacement (Δl) 502 depends on the dispersion of the dispersion compensator 108 (D_{DC}) as well as a distance between the dispersion compensator 108 and the AOD 106. As a result, the impact of this this lateral displacement (Δl) 502 may be reduced by placing the dispersion compensator 108 as close as physically possible to the AOD 106. In some applications, this lateral displacement (Δl) 502 may be relatively small compared to a size of the optical beam 102 and may be fall within application tolerances.

It is further contemplated herein that zero-order diffraction from the dispersion compensator 108 (not shown in FIG. 5) may be incident on the AOD 106 in this configuration and may thus be deflected by the AOD 106. In some cases, this zero-order diffraction may be close to or partially overlap with the deflected optical beam 102 (e.g., may be in a working region of the AOD 106). However, a dispersion compensator 108 formed as a DOE may potentially be highly efficient such that a power of this zero-order diffraction is negligible relative to a power of the deflected optical beam 102. For example, in simulations for wavelengths associated with an optical beam 102 from a CO₂ laser, this zero-order diffraction may have less than 0.2% of the power of the deflected optical beam 102.

In some embodiments, the optical scanner 100 includes one or more components between the dispersion compensator 108 and the AOD 106, which may enable further manipulation of the optical beam 102.

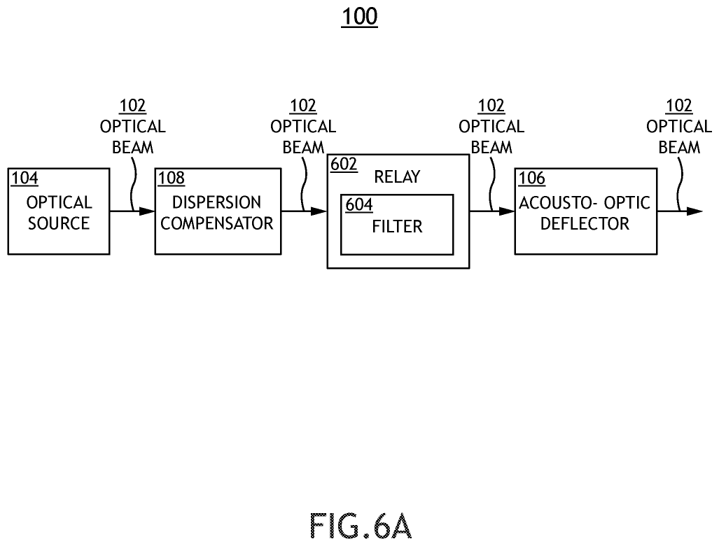

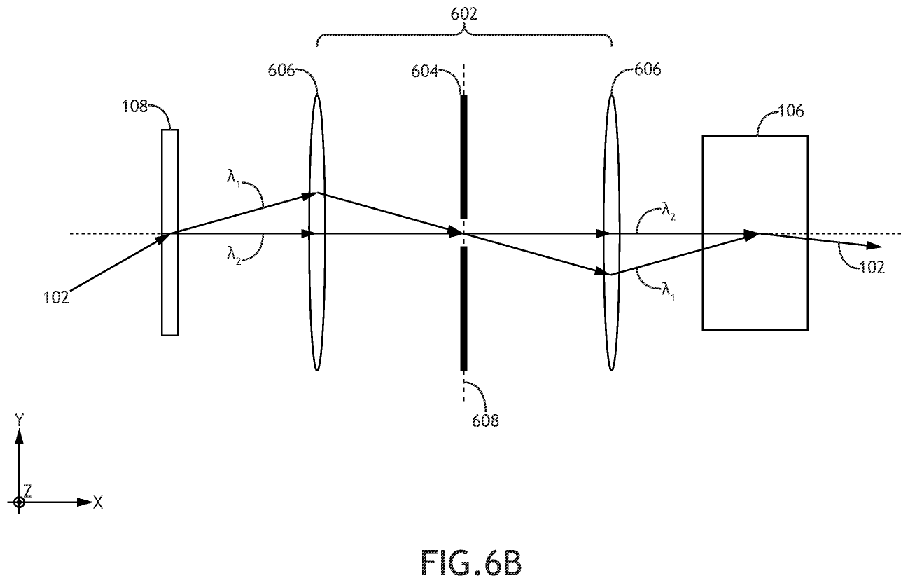

FIG. 6A is a block diagram of an optical scanner 100 including an optical relay 602 to image the dispersion compensator 108 on an AOD 106, in accordance with one or more embodiments of the present disclosure. FIG. 6B is a simplified schematic of an optical scanner 100 including an optical relay 602 to image the dispersion compensator 108 on an AOD 106, in accordance with one or more embodiments of the present disclosure.

In some embodiments, the optical scanner 100 includes an optical relay 602 to generate an image of the dispersion compensator 108 (e.g., an operational plane of the dispersion compensator 108) onto the AOD 106 (e.g., an operational plane of the AOD 106). In this way, the lateral displacement (Δl) 502 depicted in FIG. 5 is not present. Rather, light of different wavelengths may exit the dispersion compensator 108 at different angles due to the dispersion D_{DC} and may then be recombined at the AOD 106 such that there is no lateral displacement (Δl) 502 between different wavelengths. Further, the optical relay 602 may be configured to retain the dispersion induced by the dispersion compensator 108 (D_{DC}) such that different wavelengths of light are incident on the AOD 106 at are deflected with a common deflection angle 214.

The optical relay 602 may include any type of relay known in the art and may include, but is not limited to, two or more lenses and/or focusing mirrors.

In some embodiments, the optical scanner 100 further includes a filter 604 formed from one or more elements to block unwanted light (e.g., apertures, beam blocks, or the like) from the dispersion compensator 108 such as, but not limited to, unwanted diffraction orders (e.g., zero order diffraction or diffraction orders not associated with the optical beam 102). Such elements may be located at any location suitable for blocking the unwanted light including, but not limited to, a pupil plane (e.g., a diffraction plane, a Fourier plane, or the like). For example, as depicted in FIG. 6B, the optical relay 602 may include a pair of lenses 606 or other focusing optics separated by twice their focal lengths (e.g., in a 4-F arrangement) to generate a pupil plane 608 suitable for spatial filtering of unwanted light.

Multi-directional operation of the optical scanner 100 is described in greater detail, in accordance with one or more embodiments of the present disclosure.

A dispersion compensator 108 may generally be used for one-dimensional (1D) or two-dimensional (2D) scanning by one or more AODs 106. In a general sense, dispersion compensation may be achieved when the dispersion of the dispersion compensator 108 (D_{DC}) has the same magnitude but opposite sign (e.g., opposite angular sign as illustrated in FIG. 5) as the dispersion of an AOD 106 (D_{AOD}) in a particular plane in which the optical beam 102 is scanned.

Referring again to FIGS. 2 and 3A, FIGS. 2 and 3A depict an AOD 106 providing 1D scanning within the Y-Z plane (e.g., a scan plane). In particular, the AOD 106 provides a diffraction grating 206 in the X-Y plane, where a grating direction (e.g., a direction of periodicity) is along the Y direction and a thickness of the diffraction grating 206 is along the Z direction.

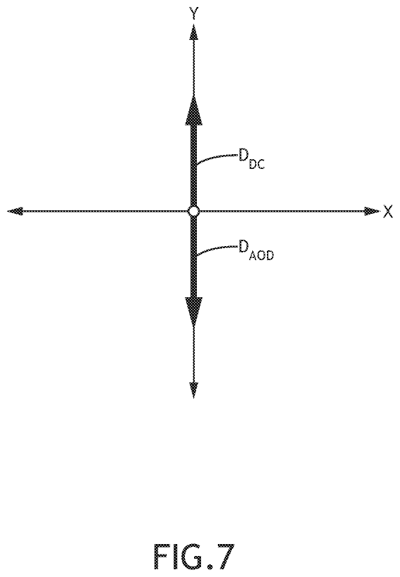

In some embodiments, the dispersion compensator 108 is arranged to provide dispersion (D_{DC}) exclusively in the same axis as an AOD 106. FIG. 7 is a conceptual view of the relative dispersion directions of a dispersion compensator 108 and a single AOD 106 arranged for 1D scanning in the Y-Z plane, in accordance with one or more embodiments of the present disclosure. In particular, FIG. 7 depicts dispersion of a single AOD 106 (D_{AOD}) as a vector pointing in the −Y direction, which is consistent with FIGS. 2 and 3A. Accordingly, an optical source 104 propagating along the Y-Z plane incident on the AOD 106 may be deflected in the −Y direction, where different wavelengths have different deflection angles 214 with an angular spread determined by the magnitude of D_{AOD} FIG. 7 further depicts dispersion of a dispersion compensator 108 (D_{DC}) as a vector pointing in the +Y direction, which is consistent with FIG. 3B. Accordingly, an optical source 104 propagating along the Y-Z plane incident on the dispersion compensator 108 may be deflected in the +Y direction, where different wavelengths have different deflection angles 214 with an angular spread determined by the magnitude of D_{DC}. When the magnitudes of D_{AOD} and D_{DC} are equal as depicted in FIG. 7, portions of the optical beam 102 having different wavelengths are deflected at a common deflection angle 214 after propagating through both the dispersion compensator 108 and the AOD 106.

In some embodiments, the dispersion compensator 108 is arranged to provide dispersion (D_{DC}) in a different direction than any particular AOD 106. In this way, a single dispersion compensator 108 may provide dispersion compensation for multiple AODs 106. FIG. 8 is a conceptual view of the relative dispersion directions of a dispersion compensator 108 and two AODs 106 arranged for 2D scanning, in accordance with one or more embodiments of the present disclosure. In particular, FIG. 8 depicts dispersion associated with two orthogonal scanning directions D_{AOD,1} and D_{AOD,2}, which may be provided by a single AOD 106 (e.g., with multiple transducers 202) or two AODs 106, each providing a different deflection direction. FIG. 8 further depicts dispersion (D_{DC}) associated with a single dispersion compensator 108 suitable for simultaneously compensating for both D_{AOD,1} and D_{AOD,2}. For example, D_{DC} is oriented at a 135-degree angle from both D_{AOD,1} and D_{AOD,2} and has a magnitude equal to \sqrt{D_{AOD,1}²−D_{AOD,2}²}. In this way, the projections of D_{DC} along the X and Y axes have the same magnitudes as both D_{AOD,1} and D_{AOD,2}, respectively, but with an opposite sign.

Referring now generally to FIGS. 7-9, the impact of polarization sensitivity of an dispersion compensator 108 and/or AODs 106 is described in greater detail. Many AODs 106 are polarization sensitive and thus benefit from or require a particular input polarization of the optical beam 102. In this case, scanning along two directions (e.g., orthogonal directions) requires rotating the polarization of the optical beam 102 accordingly between the AODs 106. Further, dispersion compensation may generally be accomplished using multiple dispersion compensators 108 (e.g., one for each AOD 106 arranged as illustrated in FIG. 7) or a single dispersion compensator 108 placed before multiple AODs 106 and oriented at an angle with respect to the AODs 106 (e.g., as illustrated in FIG. 8).

When a dispersion compensator 108 is also polarization sensitive such that the transmittance and/or dispersion depends on the polarization of the optical beam 102, it may be further necessary to rotate the polarization of the optical beam 102 prior to or after the dispersion compensator 108 to provide the required polarizations for all elements. For instance, continuing the illustration in FIG. 8, the polarization of the optical beam 102 may be rotated to an orientation required for a polarization-sensitive dispersion compensator 108 (e.g., along the dispersion direction D_{DC}), then rotated to an orientation required by the first AOD 106 (e.g., along the Y direction), and then rotated to an orientation required by the second AOD 106 (e.g., along the X direction). In a general sense, the optical scanner 100 may include waveplates or other suitable polarization rotating elements for polarization control of the optical beam 102.

However, it is contemplated herein that polarization management may be difficult or impractical for some applications. For example, it may be difficult or impractical to provide arbitrary polarization rotations of an optical beam 102 from a CO₂ laser, particularly at relatively high powers (e.g., tens or hundreds of Watts). In particular, a waveplate (e.g., a half-wave plate) suitable for operation in the spectral range of 9-12 μm may be difficult to manufacture, costly, or may have unsuitable damage thresholds. Continuing the illustration in FIG. 8, in such cases, rotating a polarization of the optical beam 102 by 135 degrees between the dispersion direction D_{DC} of the dispersion compensator 108 and the Y axis for the first AOD 106 may be difficult or impractical.

In some embodiments, the dispersion compensator 108 is polarization insensitive such that the transmittance and/or dispersion does not depend on the polarization of the optical beam 102 (at least within a selected tolerance). It is contemplated herein that such a polarization insensitive dispersion compensator 108 may be well suited for, but not limited to, providing simultaneous dispersion compensation for multiple AODs 106 (e.g., as illustrated in FIG. 8). In this configuration, the dispersion compensator 108 may be oriented along any desired angle to provide dispersion compensation for the AODs 106 without the need to adjust the polarization of the optical beam 102 for efficient operation of the dispersion compensator 108.

Continuing the illustration in FIG. 8, a polarization-insensitive dispersion compensator 108 would not require a particular polarization of the optical beam 102 for operation within selected tolerances. For example, the optical beam 102 may be aligned along the Y axis prior to the dispersion compensator 108 and then be incident on the first AOD 106 without further adjustments.

In an application including two polarization-sensitive AODs 106 oriented for deflection along at different (e.g., orthogonal) directions, the polarization of the optical beam 102 must typically be rotated between the two AODs 106 regardless of the properties of the dispersion compensator 108. It is further contemplated herein that polarization rotations of 90 degrees may be practical even when arbitrary polarization control (e.g., with a waveplate) is impossible or impractical (e.g., in the case of an optical beam 102 from a CO₂ laser).

FIG. 9 is a block diagram of an optical scanner 100 with a polarization insensitive dispersion compensator 108 arranged to provide dispersion compensation for two orthogonal polarization-sensitive AODs 106, in accordance with one or more embodiments of the present disclosure. FIG. 9 also illustrates an optical relay 602 between the dispersion compensator 108 and a first AOD 106 (e.g., as described with respect to FIGS. 6A and 6B) to avoid any lateral displacement (Δl) 502 between different wavelengths in the optical beam 102 during a scan. Although the dispersion compensator 108 is located prior to both AODs 106 in FIG. 9, this is merely and illustration and the dispersion compensator 108 may be located at any suitable location including after or between the AODs 106.

In some embodiments, the optical scanner 100 includes a polarization rotator 902 between first and second AODs 106 to rotate the polarization of the optical beam 102 to be oriented according to the requirements of the second AOD 106. As an example in an application with orthogonal AODs 106, the polarization rotator 902 may rotate the polarization of the optical beam 102 by 90 degrees. In this way, dispersion-compensated two-directional scanning may be achieved using a single polarization-insensitive dispersion compensator 108.

The polarization rotator 902 may include any components suitable for rotating the polarization of the optical beam 102. In some embodiments, the polarization rotator 902 includes one or more rhombs (e.g., Fresnel Rhombs) or prisms formed from a material transmissive to the spectrum of the optical beam 102 and designed to rotate the polarization of the optical beam 102 by 90 degrees. For example, the polarization rotator 902 may include a half-wave (e.g., λ/2) rhomb or two quarter-wave (e.g., λ/4) rhombs. As another example, the polarization rotator 902 may include one or more reflective phase retarders. A reflective phase retarder may include a reflective material designed to provide a phase shift between orthogonal polarization components upon reflection and may generally be designed for a wide range of wavelengths, powers, and phase retardation values. For example, quarter-wave (e.g., λ/4) reflective phase retarders are commonly used for high-power CO₂ laser applications to convert linearly-polarized beams to circularly-polarized beams. The polarization rotator 902 may include two quarter-wave reflective phase retarders to provide half-wave phase retardation to rotate the polarization of the optical beam 102 by 90 degrees. For instance, orienting a first quarter-wave reflective phase retarder such that a linear polarization direction of the optical beam 102 is oriented at a 45-degree angle with respect to a plane of incidence may provide a circularly-polarized optical beam 102. Similarly, orienting a second quarter-wave reflective phase retarder at a 45-degree angle may provide the optical beam 102 with a linear polarization that has been rotated by 90 degrees relative to an input state. Such a polarization rotator 902 may preserve the scanning direction.

Multi-channel operation of the optical scanner 100 is described in greater detail, in accordance with one or more embodiments of the present disclosure. In some embodiments, the optical scanner 100 includes multiple channels, each including at least one AOD 106. Further, an AOD 106 in any particular channel may provide 1D or 2D scanning. In a general sense, an optical scanner 100 may include any number of AODs 106 in any number of channels.

In some embodiments, the optical scanner 100 includes a single dispersion compensator 108 to provide dispersion compensation for all AODs 106 using configurations such as, but not limited to, those depicted in FIGS. 7 and 8. In some embodiments, the optical scanner 100 includes multiple dispersion compensators 108 located at any suitable locations including, but not limited to locations prior or within any of the channels.

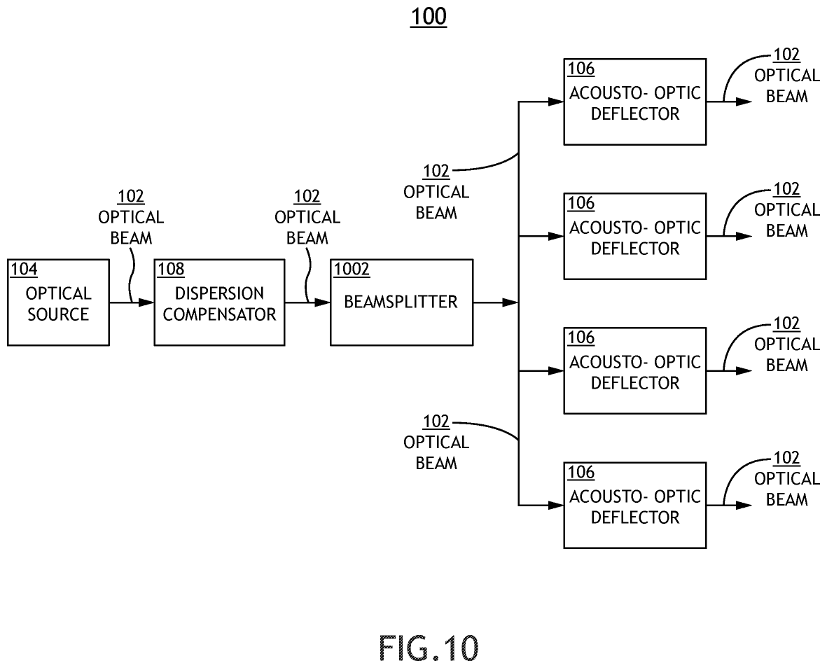

The optical scanner 100 may utilize any component or components to split an optical beam 102 into multiple channels. FIG. 10 is a block diagram of an optical scanner 100 including a beamsplitter 1002 to split a received optical beam 102 into four channels, each including at least one AOD 106, in accordance with one or more embodiments of the present disclosure. FIG. 10 further depicts a configuration in which a single dispersion compensator 108 located prior to the beamsplitter 1002 to provide dispersion compensation for all AODs 106.

In some embodiments, a dispersion compensator 108 formed as a DOE may further operate as a beamsplitter to facilitate multi-channel operation. For example, the DOE may include periodic structures along one or more directions to diffract the optical beam 102 into multiple diffraction orders. In this configuration, each diffraction order will then exhibit dispersion (D_{DC}) as described throughout the present disclosure.

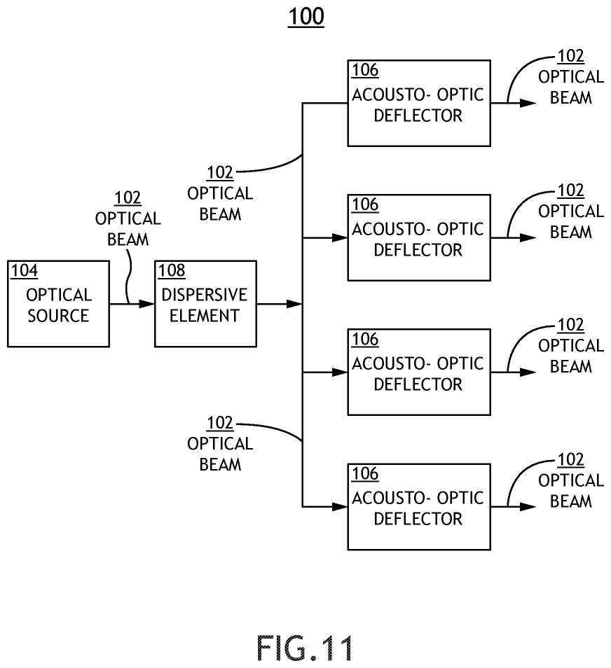

FIG. 11 is a block diagram of an optical scanner 100 including a dispersion compensator 108 providing both dispersion compensation and beamsplitting, in accordance with one or more embodiments of the present disclosure.

It is contemplated herein that a value of the dispersion (D_{DC}) may vary for different diffraction orders. Accordingly, in some embodiments, a dispersion compensator 108 formed as a DOE may diffract the optical beam 102 into multiple beams of the same diffraction order such that a magnitude of the dispersion (D_{DC}) of each beam is the same. For example, a dispersion compensator 108 formed as a DOE may split an incident optical beam 102 into two first-order diffraction beams: a +1 order diffraction beam with a dispersion vector along a +Y axis and a −1 order diffraction beam with a dispersion vector along a −Y axis. As another example, a dispersion compensator 108 formed as a DOE may split an incident optical beam 102 into four first-order diffraction beams: a +1 order diffraction beam with a dispersion vector along a +Y axis, a −1 order diffraction beam with a dispersion vector along a −Y axis, a +1 order diffraction beam with a dispersion vector along a +X axis, and a −1 order diffraction beam with a dispersion vector along a −X axis.

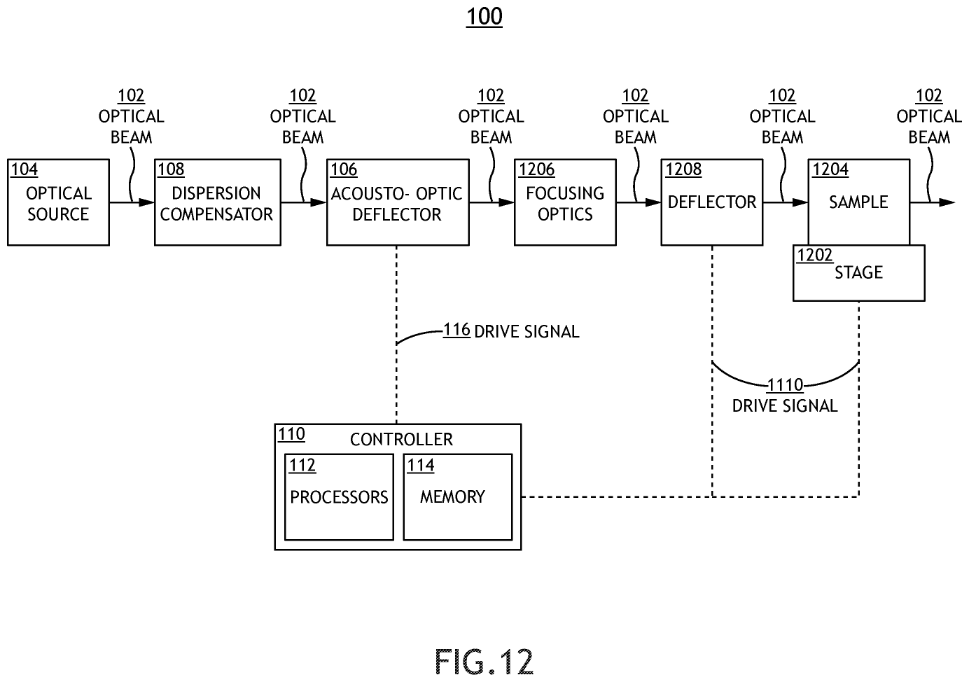

Referring now to FIG. 12, the optical scanner 100 may be suitable for operation in a larger system such as, but not limited to, a laser materials processing system. FIG. 12 is a block diagram of a system 1200 including an optical scanner 100, in accordance with one or more embodiments of the present disclosure.

In some embodiments, the system 1200 includes a stage 1202 to secure a sample 1204. In some embodiments, the system 1200 includes one or more focusing optics 1206 to focus the optical beam 102 from the optical scanner 100 onto the sample 1204. Accordingly, the system 1200 may direct or scan an optical beam 102 across the sample 1204 in any pattern, where the AOD 106 within the optical scanner 100 is adjusted to compensate for spectral variations of the optical beam 102 such that the position of the optical beam 102 on the sample 1204 may be consistent despite the spectral variations.

The focusing optics 1206 may include any number or type of focusing optics suitable for focusing the optical beam 102 onto the sample 1204. In some embodiments, the focusing optics 1206 include an F-theta lens to provide consistent focusing of the optical beam 102 across a flat plane and linear displacement across the sample 1204 as a function of input angle (e.g., associated with the deflection angle of the optical beam 102 from the optical scanner 100.

In some embodiments, the system 1200 includes one or more additional components to provide additional control over the position of the optical beam 102 on the sample 1204. For example, the stage 1202 may include a translation stage with one or more linear or angular actuators to adjust a position of the sample 1204 along any number of degrees of freedom. As another example, the system 1200 may include an additional deflector 1208 such as, but not limited to, a galvo mirror as depicted in FIG. 12, a rotating polygon, or an additional AOD. In this way, the scanning range may be increased beyond the range of the optical scanner 100. For instance, mechanical beam scanners such as the stage 1202 or the galvo mirror depicted in FIG. 12 may provide a larger scanning range than the optical scanner 100 but with relatively slower scan rates.

The system 1200 may further include any number of additional optics to control various aspects of the optical beam 102 such as, but not limited to, polarizers, spectral filters, spatial filters, or apodizers. Although not explicitly illustrated, such additional optics may be distributed at any suitable locations throughout the system 1200 and/or within the optical scanner 100.

Further, as depicted in FIG. 12, the controller 110 may be communicatively coupled with any components in the system 1200. In this way, the controller 110 may provide drive signals to any components (e.g., the drive signal 116 and/or additional drive signals 1110), receive data from any components, or the like.

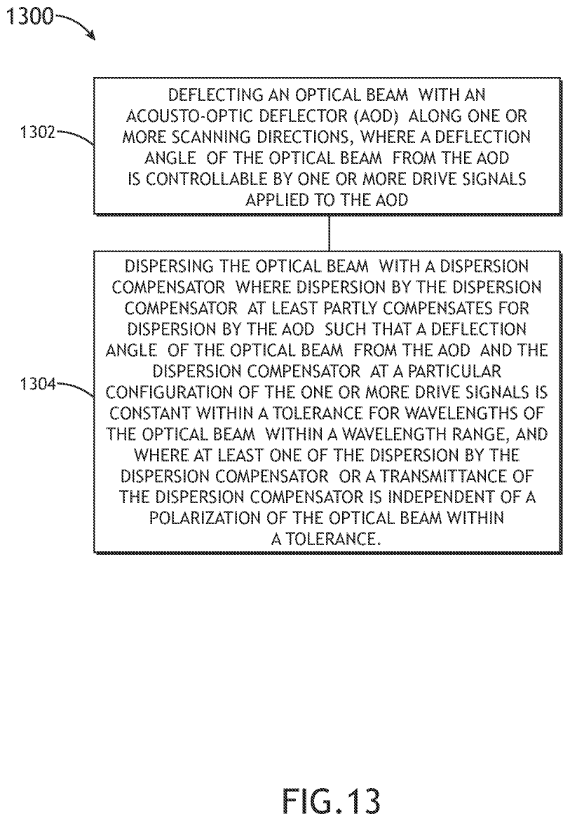

Referring now to FIG. 13, FIG. 13 is a flow diagram illustrating steps performed in a method 1300 for passive dispersion compensation of an acousto-optic deflector, in accordance with one or more embodiments of the present disclosure. Applicant notes that the embodiments and enabling technologies described previously herein in the context of the optical scanner 100 should be interpreted to extend to method 1300. It is further noted, however, that the method 1300 is not limited to the architecture of the optical scanner 100.

In some embodiments, the method 1300 includes a step 1302 of deflecting an optical beam 102 with an AOD 106 along one or more scanning directions, wherein a deflection angle 214 of the optical beam 102 from the AOD 106 is controllable by one or more drive signals applied to the AOD 106.

In some embodiments, the method 1300 includes a step 1304 of dispersing the optical beam 102 with a dispersion compensator 108, where dispersion by the dispersion compensator 108 at least partly compensates for dispersion by the AOD 106 such that a deflection angle 214 of the optical beam 102 from the AOD 106 and the dispersion compensator 108 at a particular configuration of the one or more drive signals is constant within a tolerance (e.g., a first tolerance) for wavelengths of the optical beam 102 within a wavelength range, and where at least one of the dispersion by the dispersion compensator 108 or a transmittance of the dispersion compensator 108 is independent of a polarization of the optical beam 102 within a tolerance (e.g., a second tolerance).

For example, as described with respect to the optical scanner 100, the dispersion compensator 108 may include any component or combination of components suitable for providing a dispersion (e.g., an angular dispersion) suitable for at least partially compensating the dispersion of the AOD 106 and may include, but is not limited to, a DOE or a prism.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An optical scanner comprising:
one or more acousto-optic deflectors (AODs) configured to deflect an optical beam along one or more scanning directions, wherein a deflection angle of the optical beam from the one or more AODs is controllable by one or more drive signals applied to the one or more AODs; and
a dispersion compensator, wherein dispersion by the dispersion compensator at least partly compensates for dispersion by the one or more AODs to provide that the deflection angle of the optical beam by the one or more AODs and the dispersion compensator at a particular configuration of the one or more drive signals is constant within a first tolerance for wavelengths of the optical beam within a wavelength range, wherein at least one of the dispersion of the dispersion compensator or a transmittance of the dispersion compensator is independent of a polarization of the optical beam within a second tolerance.

2. The optical scanner of claim 1, wherein the dispersion compensator comprises:
a diffractive optical element.

3. The optical scanner of claim 1, wherein the dispersion compensator comprises:
a prism.

4. The optical scanner of claim 1, wherein a magnitude of the dispersion by any one of the one or more AODs varies within an operational range associated with the corresponding one of the one or more drive signals, wherein a magnitude of the dispersion by the dispersion compensator projected along a dispersion direction associated with a particular one of the one or more AODs is equal to a magnitude of the dispersion by the particular one of the one or more AODs for at least one value of the corresponding operational range.

5. The optical scanner of claim 1, wherein the dispersion compensator is located prior to the one or more AODs.

6. The optical scanner of claim 1, wherein the dispersion compensator is located after to the one or more AODs.

7. The optical scanner of claim 1, wherein the dispersion compensator is located adjacent to one of the one or more AODs.

8. The optical scanner of claim 1, further comprising:
an optical relay between the dispersion compensator and at least one of the one or more AODs.

9. The optical scanner of claim 8, wherein the dispersion compensator comprises a diffractive optical element (DOE), wherein the optical scanner further includes a filter to block at least zero-order diffraction from the DOE.

10. The optical scanner of claim 1, wherein the one or more AODs comprise a single AOD, wherein the one or more scanning directions of the one or more AODs comprise a single scanning direction.

11. The optical scanner of claim 1, wherein the one or more scanning directions of the one or more AODs includes a first scanning direction and a second scanning direction.

12. The optical scanner of claim 11, wherein the one or more AODs comprise two AODs, wherein the first and second scanning directions are orthogonal, wherein the optical scanner further comprises:
a polarization rotator between the two AODs to rotate a polarization of the optical beam by 90 degrees.

13. The optical scanner of claim 12, polarization rotator comprises:
at least one of one or more reflective phase retarders or one or more rhombs.

14. The optical scanner of claim 1, wherein the dispersion compensator is a transmissive element.

15. The optical scanner of claim 1, wherein the dispersion compensator is a reflective element.

16. The optical scanner of claim 1, wherein the optical beam has a wavelength in a range of 9 to 12 micrometers.

17. A method comprising:
deflecting an optical beam with an acousto-optic deflector (AOD) along one or more scanning directions, wherein a deflection angle of the optical beam from the AOD is controllable by one or more drive signals applied to the AOD;
dispersing the optical beam with a dispersion compensator, wherein dispersion by the dispersion compensator at least partly compensates for dispersion by the AOD such that a deflection angle of the optical beam from the AOD and the dispersion compensator at a particular configuration of the one or more drive signals is constant within a first tolerance for wavelengths of the optical beam within a wavelength range, wherein at least one of the dispersion by the dispersion compensator or a transmittance of the dispersion compensator is independent of a polarization of the optical beam within a second tolerance.

18. The method of claim 17, further comprising:
placing the dispersive element adjacent to the AOD.

19. The method of claim 17, further comprising:
relaying the optical beam between the dispersion compensator and the AOD with an optical relay.

20. The method of claim 17, further comprising:
wherein the dispersion compensator comprises a diffractive optical element (DOE), wherein the method further comprises:
filtering at least zero-order diffraction from the DOE.

21. The method of claim 17, wherein the optical beam has a wavelength in a range of 9 to 12 micrometers.

22. An optical scanner comprising:
a dispersion compensator formed as a diffractive optical element (DOE) configured to diffract an optical beam into two or more diffracted beams along two or more directions, wherein at least one of dispersion by the dispersion compensator or a transmittance of the dispersion compensator is independent of a polarization of the optical beam within a first tolerance;
two or more acousto-optical deflectors (AODs) to receive the two or more diffracted beams and deflect the two or more diffracted beams, wherein deflection angles of the diffracted beams from the two or more AODs are controllable by drive signals applied to the two or more AODs, wherein dispersion by the dispersion compensator at least partly compensates for dispersion by the two or more AODs to provide that the deflection angles of the diffracted beams by the dispersion compensator and the two or more AODs at a particular configuration of the one or more drive signals are constant within a second tolerance for wavelengths of the optical beam within a wavelength range.

23. The optical scanner of claim 22, wherein each of the two or more diffracted beams corresponds to first-order diffraction by the DOE.

24. The optical scanner of claim 22, wherein the two or more diffracted beams comprise:
two diffracted beams.

25. The optical scanner of claim 22, wherein the two or more diffracted beams comprise:
four diffracted beams.

26. The optical scanner of claim 22, wherein the DOE is a transmissive element.

27. The optical scanner of claim 22, wherein the DOE is a transmissive element.

28. The optical scanner of claim 22, wherein the optical beam has a wavelength in a range of 9 to 12 micrometers.

29. A system comprising:
an optical source configured to generate an optical beam;
a scanner comprising:
one or more acousto-optic deflectors (AODs) configured to deflect an optical beam along one or more scanning directions, wherein a deflection angle of the optical beam from the one or more AODs is controllable by one or more drive signals applied to the one or more AODs; and
a dispersion compensator, wherein dispersion by the dispersion compensator at least partly compensates for dispersion by the one or more AODs such that the deflection angle of the optical beam by the dispersion compensator and the one or more AODs at a particular configuration of the one or more drive signals is constant within a first tolerance for wavelengths of the optical beam within a wavelength range, wherein at least one of the dispersion by the dispersion compensator or a transmittance of the dispersion compensator is independent of a polarization of the optical beam within a second tolerance; and
one or more focusing optics configured to focus the optical beam deflected by the one or more AODs to a sample.

30. The system of claim 29, wherein the optical beam has a wavelength in a range of 9 to 12 micrometers.
